(19) United States
(12) Patent Application Publication
(10) Pub. No.: US 2024/0177253 A1
(43) Pub. Date: May 30, 2024

(54) HOUSING SLOT EXCHANGES

(71) Applicant: Ian Abbott, New York City, NY (US)

(72) Inventor: Ian Abbott, New York City, NY (US)

(21) Appl. No.: 18/059,619

(22) Filed: Nov. 29, 2022

(51) Int. Cl. G06Q 50/16; E04B 1/348; E04H 1/00; G06Q 10/083; G06Q 20/36; G06Q 30/08

(52) U.S. Cl. CPC G06Q 50/165; E04B 1/34807; E04H 1/005; G06Q 10/083; G06Q 20/3678; G06Q 30/08; G06Q 2220/00

(57) ABSTRACT

Described herein are examples of housing slot exchanges. Embodiments may include a housing module, a destination housing module slot, a logistics subsystem, and a controller. The housing module may provide a living space for a user. The logistics subsystem may provide a living space for a user. The controller may include a processor. The processor may issue tokens to users, receive bids for housing module slots, assign housing slots to users, associate bids from users with housing slots, and issue housing module move instructions to the logistics subsystem.

### BACKGROUND

Housing shortages persist globally. Particularly, in high-demand or otherwise concentrated communities, such as cities or trending communities, land is scarce and building costs are high. In low-demand areas, land is available and building costs are low. Modular and tiny homes are increasing in popularity; meanwhile, mobile homes and mobile home parks are stigmatized and there has been little innovation. Housing shortages in the United States are estimated at 5-7 million fewer units in inventory than are necessary.

### BRIEF DESCRIPTION OF THE DRAWINGS

The present description will be understood more fully when viewed in conjunction with the accompanying drawings of various examples of housing slot exchanges. The description is not meant to limit the housing slot exchanges to the specific examples. Rather, the specific examples depicted and described are provided for explanation and understanding of housing slot exchanges. Throughout the description the drawings may be referred to as drawings, figures, and/or FIGS.

FIG. 1 illustrates a modular housing system, according to an embodiment.

FIG. 2 illustrates a housing slot exchange system, according to an embodiment.

FIG. 3 illustrates a device schematic for various devices used in the housing slot exchange system, according to an embodiment.

FIG. 4 illustrates a development, according to an embodiment.

FIG. 5 illustrates a housing module building, according to an embodiment.

FIG. 6 illustrates a high bay system, according to an embodiment.

FIG. 7 illustrates a housing module logistics system, according to an embodiment.

FIG. 8 illustrates a housing module logistics system, according to an embodiment.

FIG. 9 illustrates a housing module, according to an embodiment.

FIG. 10 illustrates a housing slot exchange mechanism system, according to an embodiment.

### DETAILED DESCRIPTION

A housing slot exchange as disclosed herein will become better understood through a review of the following detailed description in conjunction with the figures. The detailed description and figures provide merely examples of the various embodiments of housing slot exchanges. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

The conventional housing market relies on management of inventory, development, and brokerages of sales of houses. Particularly, sales of housing generally include a listing stage, an offer stage, a negotiation stage, and a closing stage. The parties involved may include an owner, a developer, a broker, a buyer, and others. The incentives for the owner may relate to growing value, having a high-quality house, and/or if the owner becomes a seller, obtaining the highest possible price for their house. The incentives for a developer may relate to spending the least possible capital and least possible time developing a house. The incentives for a broker, whether representing the seller or the buyer, may relate to selling the house at the highest price possible (thereby obtaining a higher commission) in the shortest amount of time (thereby selling more inventory). The incentives for the buyer may relate to buying the house at the lowest price possible in the shortest amount of time.

Problems include that asset dwelling tech doesn't work like other tech because of how the market treats dwellings, as well as misaligned incentives between the parties involved in any given transaction. For example, the developer and the owner naturally do not have compatible incentives (quality and durability vs. speed and low-expense), and the buyer and the broker naturally do not have compatible incentives (high price vs. low price).

Furthermore, when housing is treated as an asset, this may be considered the financialization issue. There is strong motivation from individual owners for prices to rise but the market overall, like with any technology, wants prices to come down over time.

Since houses are usually a tied to land due to the inability for them to be easily moved in and out, models of leasing the structure and upgrading each year are limited. A house thus is generally not considered a liquid or fungible asset. Housing ownership can be fractionalized to make a single house slightly more liquid, but these fractions are not very fungible as they are generally still tied to a physical structure attached to a definitionally-unmovable location and may be disconnected from other structures attached to their locations (e.g., not shares of one common entity but rather shares in different entities with fungibility difficulties).

Implementations of housing slot exchanges may address some or all of the problems described above. Embodiments may include a housing module, a destination housing module slot of a destination housing module building of a destination housing module development, an origination housing module slot of an origination housing module building of an origination housing module development, a logistics subsystem, and a controller. The housing module may provide a living space for a user. The logistics subsystem may provide a living space for a user. The controller may include a processor. The processor may issue tokens to users, assign token values to housing module slots based on demand, receive bids for housing module slots, assign housing slots to users, associate bids from users with housing slots, and issue housing module move instructions to the logistics subsystem.

A housing slot exchange may include a protocol and platform for the storage, transfer and docking of containerized spaces (think container homes and commercial units). Embodiments may include building a collection of habitable high-bay systems (frames) along transportation systems (e.g., railways). Container homes may dock into slots that line these frames. The frames may raise, lower, and shuffle the units within them in random access or otherwise fashion as well as hand them off to the rail. The rail transfers the units between frames may be installed in different locations. Embodiments may include compact, distributed, and mobile sites. An ability of embodiments to reorganize elements make them a fungible built environment. A liquid nature of embodiments may enable new markets as well as urban dynamics. Embodiments may enable geographically separated areas to share services and residences in a smooth way. Embodiments may apply high bay technology from shipping, storage and logistics to housing, transportation and retail embodiments may enable more interactions between people places and things, providing room for new urban dynamics and realize aspects of agglomeration but in a distributed way. Embodiments may include selling tokens that symbolize parking access to the slots for your units. Such tokens may also be used by users as incentive pay to trade slots with them or move.

Functionally, a housing slot exchange may facilitate both commercial and logistical 1 interactions between the various actors therein. In practice, each user of the housing slot exchange may each carry a balance of tokens. There may be a total number of tokens within system 1000, equaling the total of all tokens belonging to each of the users. Each user may be entitled to allocate a portion of their balance of tokens towards assignment of a given slot. Other users may also allocate varying quantities of tokens toward assignment of the slot. In this way, a number of users may bid for the given slot. If the slot becomes vacant, the user with the highest bid may be assigned the given slot by the housing slot exchange. Furthermore, each user may enter system 1000 with a given balance of tokens. In some embodiments, additional tokens may be purchased from the controller, in other embodiments, the total number of tokens within housing slot exchange may be fixed. In either instance, users may exchange tokens with other users, for example, as an incentive to vacate desired slots. This could, for example, occur when a user has placed the maximum allowable (or possible) bid for a given slot, but needs to offer an incentive to the existing user of slot to vacate the slot.

The value of the tokens in fiat currency, for example, tokens may be valued in a certain quantity of U.S. Dollars (e.g., the tokens may be “pegged” to the U.S. Dollar). Alternatively, the housing slot exchange may peg the value of tokens to another cryptocurrency, or to no currency at all. As such, given the value of the tokens a prospective user may buy into housing slot exchange, thereby becoming able to utilize the logistics the housing slot exchange.

Embodiments may address some or all of the problems with the conventional housing market by providing an avenue of homeownership and asset value retention not apparent with respect to the conventional housing market. Furthermore, embodiments may align interests of the parties involved in housing transactions, as the owner/seller would have the incentive for price to go down to support a move. Moreover, embodiments may enable aspects of fungibility to land from the user's perspective, by allowing users to swap locations of their modular homes, and from a developer's perspective for the same reason.

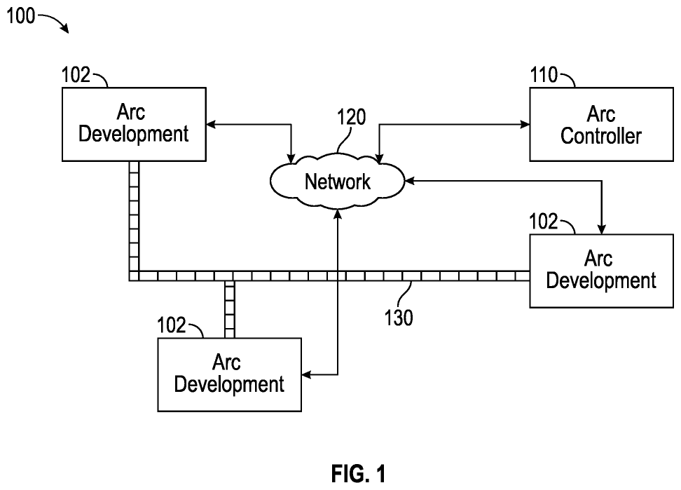

FIG. 1 illustrates a modular housing system 100, according to an embodiment. Modular housing system 100 may provide for an ability for a user of modular housing system 100 to move houses between modular housing developments (e.g., development(s) 102). Thus, modular housing system 100 may align incentives between various entities involved in the locating, sales, leasing, and development of housing.

Modular housing system 100 may include one or more development(s) 102. Development(s) 102 may be connected by physical logistics system(s) 130 and virtually via network(s) 120.

Network(s) 120 may be controlled by a controller(s) 110. Various of these components will be discussed in further detail herein.

Modular housing system 100 may operate to enable users of the modular housing system 100

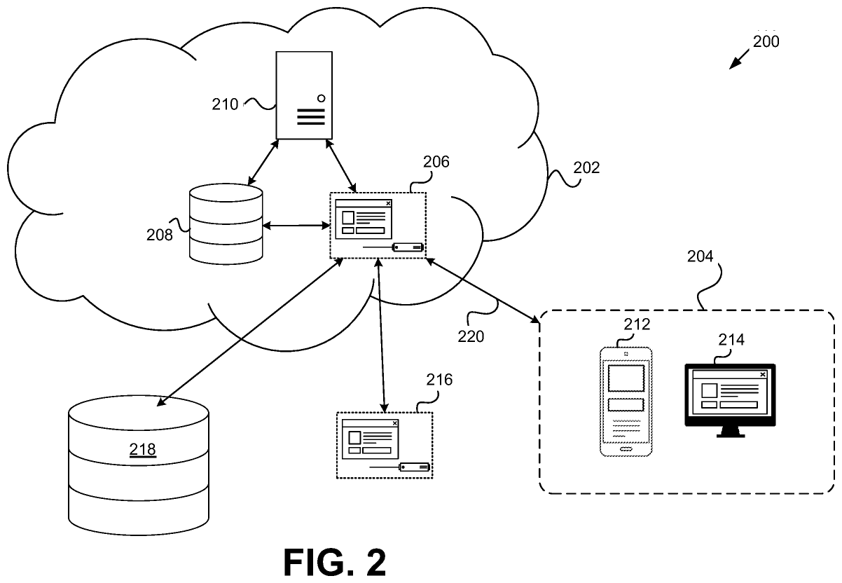

FIG. 2 illustrates a housing slot exchange system 200, according to an embodiment. The housing slot exchange system 200 includes internal and external data resources for managing a project. The housing slot exchange system 200 may result in reduced memory allocation at client devices and may conserve memory resources for application servers.

The housing slot exchange system 200 may include a cloud-based data management system 202 and a user device 204. The cloud-based data management system 202 may include an application server 206, a database 208, and a data server 210. The user device 204 may include one or more devices associated with user profiles of the housing slot exchange system 200, such as a smartphone 212 and/or a personal computer 214. The housing slot exchange system 200 may include external resources such as an external application server 216 and/or an external database 218. The various elements of the housing slot exchange system 200 may communicate via various communication links 220. An external resource may generally be considered a data resource owned and/or operated by an entity other than an entity that utilizes the cloud-based data management system 202 and/or the user device 204.

The housing slot exchange system 200 may be web-based. The user device 204 may access the cloud-based data management system 202 via an online portal set up and/or managed by the application server 206. The housing slot exchange system 200 may be implemented using a public internet. The housing slot exchange system 200 may be implemented using a private intranet. Elements of the housing slot exchange system 200, such as the database 208 and/or the data server 210, may be physically housed at a location remote from an entity that owns and/or operates the housing slot exchange system 200. For example, various elements of the housing slot exchange system 200 may be physically housed at a public service provider such as a web services provider. Elements of the housing slot exchange system 200 may be physically housed at a private location, such as at a location occupied by the entity that owns and/or operates the housing slot exchange system 200.

The communication links 220 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 220, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 220, may refer to any of the aforementioned indirect communication links.

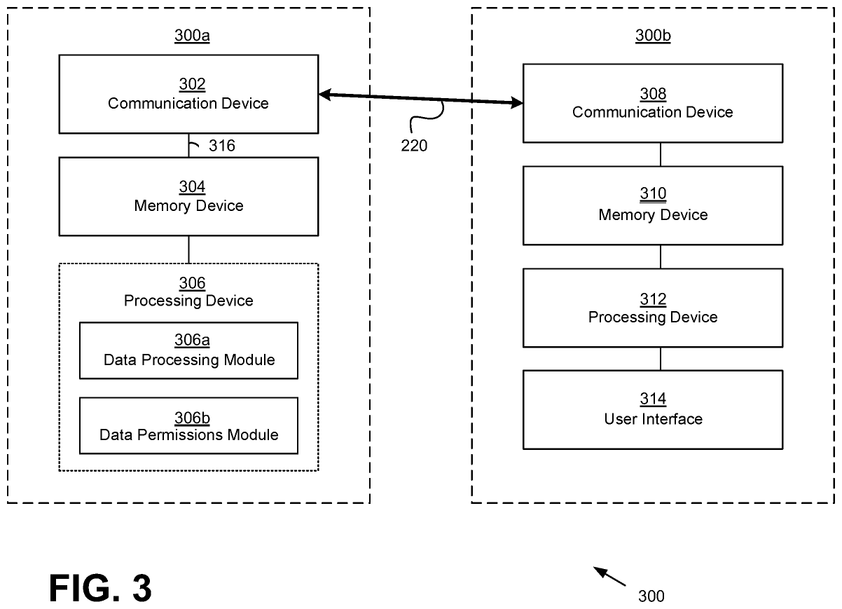

FIG. 3 illustrates a device schematic 300 for various devices used in the housing slot exchange system 200, according to an embodiment. A server device 300a may moderate data communicated to a client device 300b based on data permissions to minimize memory resource allocation at the client device 300b.

The server device 300a may include a communication device 302, a memory device 304, and a processing device 306. The processing device 306 may include a data processing module 306a and a data permissions module 306b, where module refers to specific programming that governs how data is handled by the processing device 306. The client device 300b may include a communication device 308, a memory device 310, a processing device 312, and a user interface 314. Various hardware elements within the server device 300a and/or the client device 300b may be interconnected via a system bus 316. The system bus 316 may be and/or include a control bus, a data bus, and address bus, and so forth. The communication device 302 of the server device 300a may communicate with the communication device 308 of the client device 300b.

The data processing module 306a may handle inputs from the client device 300a. The data processing module 306a may cause data to be written and stored in the memory device 304 based on the inputs from the client device 300b. The data processing module 306a may retrieve data stored in the memory device 304 and output the data to the client device 300a via the communication device 302. The data permissions module 306b may determine, based on permissions data stored in the memory device, what data to output to the client device 300b and what format to output the data in (e.g. as a static variable, as a dynamic variable, and so forth). For example, a variable that is disabled for a particular user profile may be output as static. When the variable is enabled for the particular user profile, the variable may be output as dynamic.

The server device 300a may be representative of the cloud-based data management system 202. The server device 300a may be representative of the application server 206. The server device 300a may be representative of the data server 210. The server device 300a may be representative of the external application server 216. The memory device 304 may be representative of the database 208 and the processing device 306 may be representative of the data server 210. The memory device 304 may be representative of the external database 218 and the processing device 306 may be representative of the external application server 216. For example, the database 208 and/or the external database 218 may be implemented as a block of memory in the memory device 304. The memory device 304 may further store instructions that, when executed by the processing device 306, perform various functions with the data stored in the database 208 and/or the external database 218.

Similarly, the client device 300b may be representative of the user device 204. The client device 300b may be representative of the smartphone 212. The client device 300b may be representative of the personal computer 214. The memory device 310 may store application instructions that, when executed by the processing device 312, cause the client device 300b to perform various functions associated with the instructions, such as retrieving data, processing data, receiving input, processing input, transmitting data, and so forth.

As stated above, the server device 300a and the client device 300b may be representative of various devices of the housing slot exchange system 200. Various of the elements of the housing slot exchange system 200 may include data storage and/or processing capabilities. Such capabilities may be rendered by various electronics for processing and/or storing electronic signals. One or more of the devices in the housing slot exchange system 200 may include a processing device. For example, the cloud-based data management system 202, the user device 204, the smartphone 212, the personal computer 214, the external application server 216, and/or the external database 218 may include a processing device. One or more of the devices in the housing slot exchange system 200 may include a memory device. For example, the cloud-based data management system 202, the user device 204, the smartphone 212, the personal computer 214, the external application server 216, and/or the external database 218 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the housing slot exchange system 200. Such memory allocation may be based on instructions stored in the memory device. Memory resources at a specific device may be conserved relative to other systems that do not associate variables and other object with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the housing slot exchange system 200 may include data communication capabilities. Such capabilities may be rendered by various electronics for transmitting and/or receiving electronic and/or electromagnetic signals. One or more of the devices in the housing slot exchange system 200 may include a communication device, e.g., the communication device 302 and/or the communication device 308. For example, the cloud-based data management system 202, the user device 204, the smartphone 212, the personal computer 214, the application server 216, and/or the external database 218 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the housing slot exchange system 200 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the housing slot exchange system 200, including the server device 300a and/or the client device 300b, may include a user interface for outputting information in a format perceptible by a user and receiving input from the user, e.g., the user interface 314. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the data analysis system 200 and/or various elements of the data analysis system described above. For example, inputs indicated as being received in a method may be input at the client device 300b and/or received at the server device 300a. Determinations made in the methods may be outputs generated by the processing device 306 based on inputs stored in the memory device 304. Correlations performed in the methods may be executed by the correlation module 306a. Inference outputs may be generated by the inference module 306b. Key data and/or actionable data may be stored in the knowledge database 304b. Correlations between key data and actionable data may be stored in the knowledge database 304b. Outputs generated in the methods may be output to the output database 304c and/or the client device 300b. In general, data described in the methods may be stored and/or processed by various elements of the data analysis system 200.

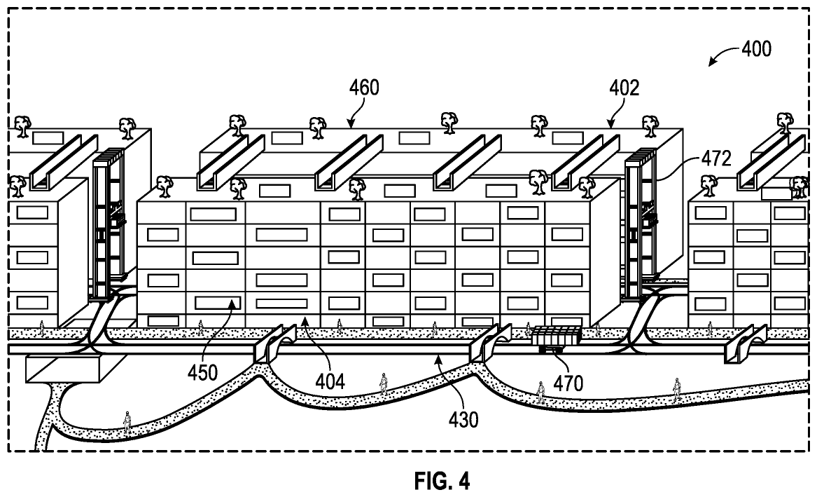

FIG. 4 illustrates a development 400, according to an embodiment. Development 400 may provide for the modular locating of housing modules. Development 400 may thus remove the need for dependence on a particular location for a housing module as multiple developments 400 may be built to permit movement of housing modules between each such development 400.

Development 400 may include one or more housing module racks 402. Each housing module rack 402 may include a variety of components necessary to support housing modules, such as a housing module 450. Each housing module rack 402 may include one or more housing module slots 404, which may be sized so as to house a housing module 450. Housing module 450 may be delivered to development 400 and/or housing module rack 402 via a placement system 430. Placement system 430 may include a variety of methods of transporting housing module 450, including rail and truck. Such rail may be a standard rail or a rail for transporting housing modules 450. Housing module 450 may be placed onto a housing module rack 402 by, for example, a high-bay system.

Housing module 450 may be delivered to housing module rack 402 via placement system 430. Upon arrival at housing module rack 402, housing module 450 may be placed into a housing module slot 404 of housing module rack 402 using a rack placement system. Housing module rack 402 may include built-in components for providing user access to housing module 450, including an elevator 470 and a stairwell 472.

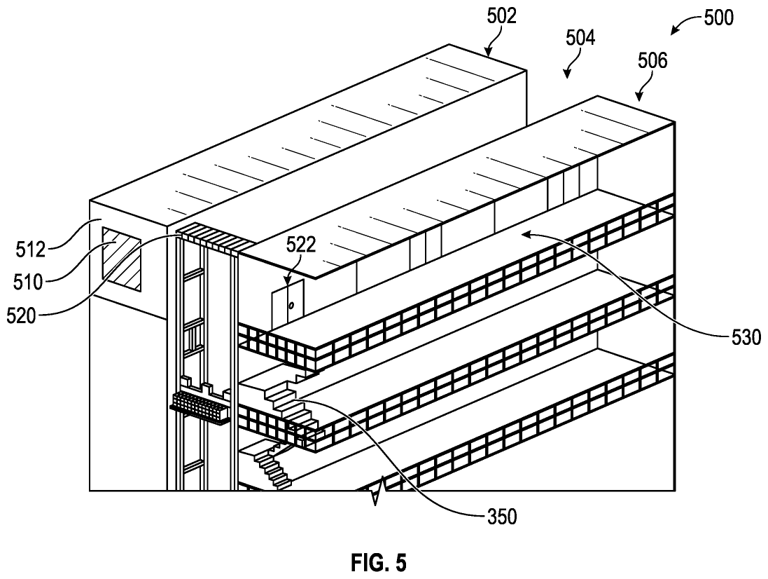

FIG. 5 illustrates a housing module building 500, according to an embodiment. Housing module building 500 may be located within a development and may provide a structure for locating and supporting (both structurally and logistically) one or more housing modules.

Housing module building 500 may include a variety of components, systems, and logistics necessary for operation of housing modules, such as housing module 510. Housing module building 500 may include multiple rack rows, for example housing module row 502, housing module row 504, and housing module row 506. Different of the rows may house various components of the housing module building 500. For example, housing module row 502 may have one or more housing modules 510 disposed therein. Housing module row 504 may have one or more solariums 520 disposed therein. Each solarium 520 may be used to interface between housing module 510 and a hallway 530. Hallway 530 may be disposed in housing module row 506 and may include a shared space. Solarium 520 may be accessible via a door 522, and solarium 520 may include an exclusive space extending a living space provided by housing module 510. Each hallway 530 may be disposed on a different floor of housing module building 500. Access between floors of housing module building 500 may include via a stairwell 550 and/or an elevator 560. Each solarium 520 may include a glass wall on a side of hallway 530 so as to enable users of housing module 510 to view outside. The glass wall may include, for example a one-way glass wall.

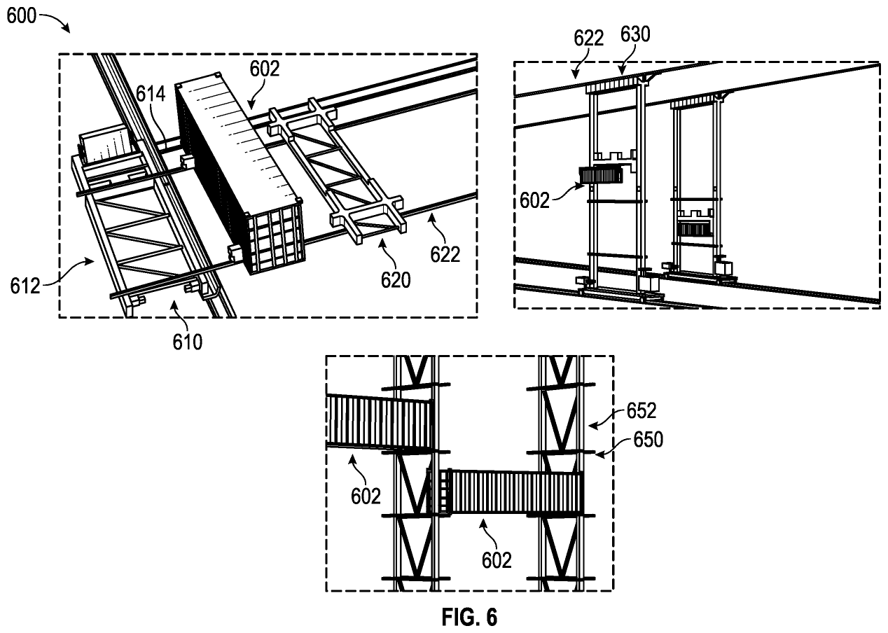

FIG. 6 illustrates a high bay system 600, according to an embodiment. High bay system 600 may provide for the movement and lifting of housing modules into slots within a housing module building. High bay system 600 may provide for mechanized lifting of housing modules thereby reducing manual labor.

High bay system 600 may be used to store housing modules 602 within a housing module building. High bay system 600 may include housing module placement system 610 and housing module placement system 620, which may attach to housing module 602. Housing module placement system 610 may be disposed on housing module placement car 622, which may in turn move on housing module placement track 614. Housing module 602 may be lifted into place using a housing module elevator 630, which may move on housing module placement car 622 and housing module placement car 612. Housing module elevator 630 may include a mechanism, which may lift housing module 602 into a housing module slot 652 of a housing module frame 650.

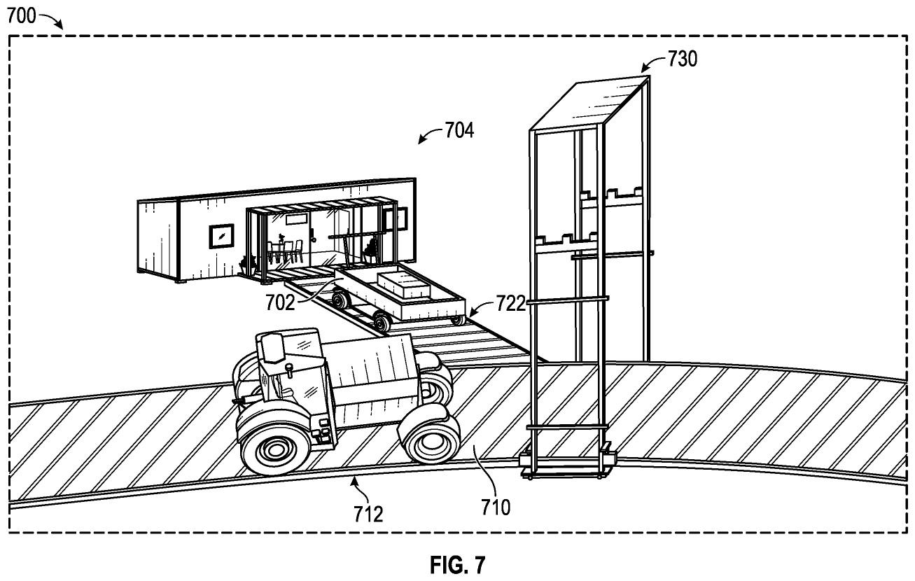

FIG. 7 illustrates a housing module logistics system 700, according to an embodiment. Housing module logistics system 700 may provide for the transportation of housing modules such as a housing module 702 between buildings housing module 702.

Housing module logistics system 700 may include a housing module transport car 710, which may be used to transport a housing module 702 to or from a housing module building 704. At housing module building 704, a placement system may place housing module 702. Housing module transport car 710 may travel between developments on a housing module transport main track 712 and may travel within developments on a housing module transport branch track 722. Housing module transport branch track housing module transport branch track 722 may be connected to housing module transport main track 712, for example, at a switch, for moving housing module transport car 710 from housing module transport main track 712 to housing module transport branch track 722. Alternately, a housing module transport lift 730 may be used to move housing module 702 from housing module transport car 710 to a like module on housing module transport branch track 722 designed to transport housing module 702 between housing module transport main track 712 and building 704.

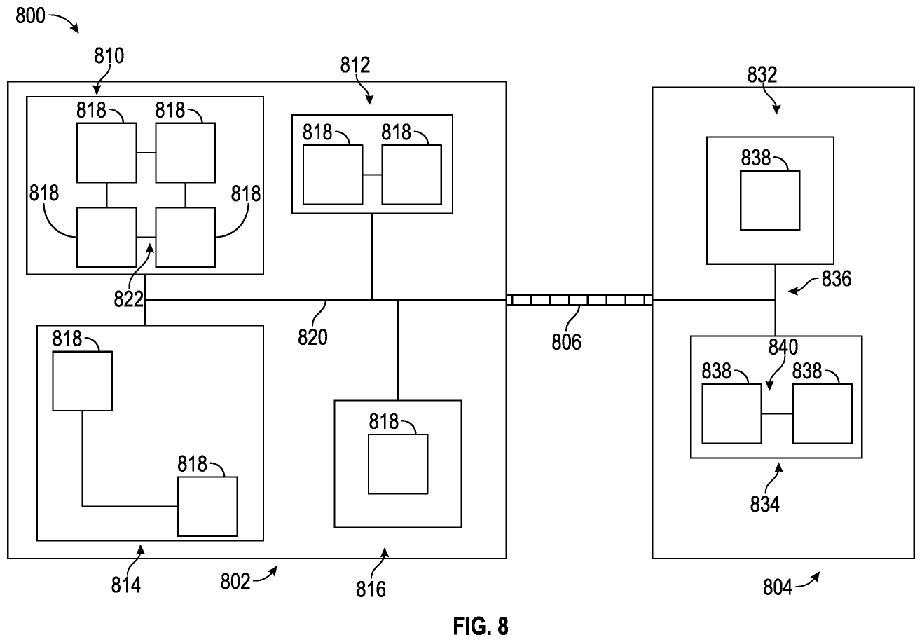

FIG. 8 illustrates a housing module logistics system 800, according to an embodiment. FIG. 8 may illustrate an example housing module logistics system 800, showing the main and branch connections between housing modules.

In the example provided by housing module logistics system 800, there may be two developments, that is, housing module development 802 and housing module development 804. Within each development, there may be multiple housing module buildings, those being housing module building 810, housing module building 812, housing module building 814, and housing module building 816 within housing module building 802 and housing module building 832 and housing module building 834 within housing module building 804. Within each building may be one or more housing module sections, those being housing module(s) 818 connected by intra-building logistics 822 within housing module building 810, housing module building 812, housing module building 814, and housing module building 816, and housing module(s) 838 connected by intra-building logistics 840 within housing module building 832 and housing module building 834. Intra-development logistics 820 may connect housing module building 810, housing module building 812, housing module building 814, and housing module building 816 within housing module building 802. Intra-development logistics 836 may connect housing module building 832 and housing module building 834 within housing module building 804.

Such intra-development logistics 820, intra-building logistics 822, intra-development logistics 836 and intra-building logistics 840 may include various logistical aspects necessary to support living within the housing modules of housing module building 802 and housing module building 804. For example, such logistics may include utilities such as grey water, a clean water, fiber optics, power, and HVAC to the common areas and the adapter where the housing modules connect with them. Such utilities may terminate inside of an adapter, which may connect each housing module to the frames, thereby enabling their function and enabling an offloading of many systems such as centralize heating cooling, HVAC, and other utilities.

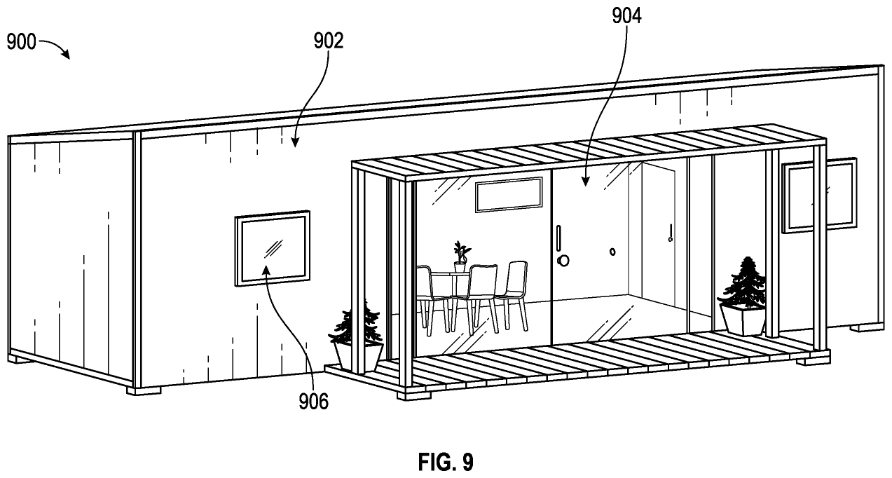

FIG. 9 illustrates a housing module 900, according to an embodiment. Housing module 900 may provide an affordable and portable housing asset for user of a housing slot exchange. Housing module 900 may be constructed using a variety of techniques but may provide for amenities necessary for sustaining life and/or a lifestyle (e.g., a kitchen, bathroom, bedroom, common room, etc.).

Housing module 900 may include various external aspects found on a modular housing unit, for example, a wall 902, a door 904, a window 906, and other aspects. In some embodiments, housing module 900 may be disposed such that 902 is a wall shared with a solarium, which may be a private module available to the user of housing module 900 to extend that user's living space when housing module 900 is attached thereto. In such an example, window 906 may open to the solarium and door 904 may open to the solarium also.

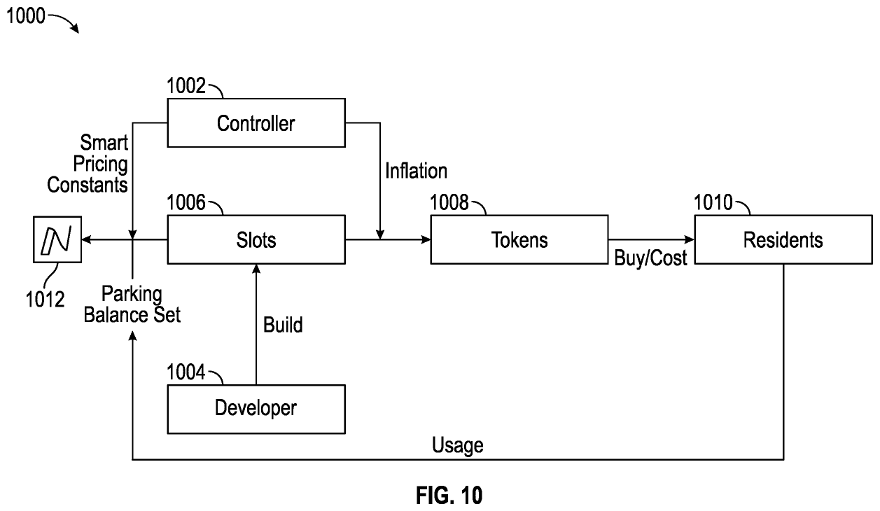

FIG. 10 illustrates a housing slot exchange mechanism system 1000, according to an embodiment. System 1000 may provide for users of system 1000 to exchange housing slots on the system virtually, which may enable and/or trigger movement of their physical housing modules between slots on system 1000.

System 1000 may include one or more controller(s) 1002, developer(s) 1004, housing module slot(s) 1006, token(s) 1008, resident user(s) 1010, and housing module(s) 1012. Developer 1004 may function to build 1006, which may be used to house housing module(s) 1012 belonging to user(s) 1010.

The functionality of system 1000 may include commercial interactions between the various actors therein. In practice, user(s) 1010 may each carry a balance of token(s) 1008. There may be a total number of token(s) 1008 within system 1000, equaling the total of all token(s) 1008 belonging to each of user(s) 1010. Each user(s) 1010 may be entitled to allocate a portion of their balance of token(s) 1008 towards assignment of slot(s) 1006. This portion of user(s) 1010 balance may be associated with a won housing slot 1006 by controller 1002. Each user(s) 1010 may allocate varying quantities of token(s) 1008 toward assignment of the slot(s) 1006. In this way, a number of user(s) 1010 may bid for the given slot 1006. If the slot 1006 becomes vacant, the user(s) 1010 with the highest bid may be assigned the given slot by the controller 1002. Furthermore, each user(s) 1010 may enter system 1000 with a given balance of token(s) 1008. In some embodiments, additional token(s) 1008 may be purchased from the controller, in other embodiments, the total number of token(s) 1008 within system 1000 may be fixed. In either instance, user(s) 1010 may exchange token(s) 1008 with other users, for example, as an incentive to vacate given slot(s) 1006. This could, for example, occur when a user(s) 1010 has placed the maximum possible bid for a given slot(s) 1006, but needs to offer an incentive to the existing user(s) 1010 of slot(s) 1006 to vacate slot(s) 1006. The tokens, balances, and slot assignments may be recorded in a database of controller 1002.

Controller(s) 1002 of the system 1000 may set the value of token(s) 1008 in fiat currency, for example, token(s) 1008 may be valued in a certain quantity of U.S. Dollars (e.g., the token(s) 1008 may be “pegged” to the U.S. Dollar). Alternatively, controller(s) 1002 may peg the value of token(s) 1008 to another cryptocurrency. As such, given the value of token(s) 1008 a prospective user(s) 1010 may buy into system 1000, thereby becoming able to utilize the logistics of system 1000.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a housing module configured to provide a living space for a user;
a destination housing module development comprising a destination housing module building, wherein:
the destination housing module building includes a destination housing module slot;
the destination housing module building includes a utilities interface configured to interface between one or more utilities and the housing module;
an origination housing module development comprising an origination housing module building, wherein:
the origination housing module building includes an origination housing module slot; and
the origination housing module building includes a further utilities interface configured to interface between one or more further utilities and the housing module;
a logistics subsystem comprising:
an inter-development housing module transport configured to transport the housing module from the origination housing module development and to transport the housing module to the destination housing module development; and
an inter-building housing module transport configured to transport the housing module from the origination housing module building within the origination housing module development and to transport the housing module to the destination housing module building within the destination housing module development;
wherein:
the logistics subsystem is configured to, in response to a housing module move instruction issued by a controller, transport the housing module from the origination housing module slot and transport the housing module to the destination housing module slot; and
the controller comprising:
a processor; and
an electronic storage device in electronic communication with the processor, the electronic storage device having a token balance database and a housing module assignment database stored thereon;
wherein the processor is configured to:
issue a plurality of tokens to the user, thereby yielding a user token balance;
record the user token balance in the token balance database;
receive a bid for the housing module slot, the bid corresponding to a portion of the user token balance;
assign the housing slot to the user;
record the assignment of the housing slot to the user in the housing module assignment database;
associate the bid from the user token balance with the housing slot; and
issue the housing module move instruction to the logistics subsystem to transport the housing module to the destination housing module slot.

2. The system of claim 1, wherein the user token balance is stored in a cryptocurrency wallet of the user.

3. The system of claim 2, wherein the cryptocurrency wallet is configured to exchange a portion of the user token balance for a further cryptocurrency.

4. The system of claim 1, wherein the bid is received by the controller from a remote device corresponding to the user.

5. The system of claim 4, wherein:
the remote device is configured to display to the user a graphical user interface for making the bid; or
the remote device is configured to mask a cryptocurrency aspect of the plurality of tokens.

6. The system of claim 1, wherein the logistics subsystem further comprises an intra-building housing module transport configured to transport the housing module from the origination housing module slot within the housing module building and to transport the housing module to the destination housing module slot within the housing module building.

7. The system of claim 1, comprising a plurality of housing module slots.

8. The system of claim 7, wherein the system comprises more housing slots than users.

9. A method, comprising:
providing a housing module configured to provide a living space for a user;
providing a destination housing module development comprising a destination housing module building, wherein:
the destination housing module building includes a destination housing module slot;
the destination housing module building includes a utilities interface configured to interface between one or more utilities and the housing module;
providing a logistics subsystem comprising:
an inter-development housing module transport configured to transport the housing module to the destination housing module development; and
an inter-building housing module transport configured to transport the housing module to the destination housing module building within the destination housing module development;
wherein:
the logistics subsystem is configured to, in response to a housing module move instruction issued by a controller, transport the housing module to the destination housing module slot; and
the controller comprising:
a processor; and
an electronic storage device in electronic communication with the processor, the electronic storage device having a token balance database and a housing module assignment database stored thereon;
using the processor:
issuing a plurality of tokens to the user, thereby yielding a user token balance;
recording the user token balance in the token balance database;
receiving a bid for the housing module slot, the bid corresponding to a portion of the user token balance;
assigning the housing slot to the user;
recording the assignment of the housing slot to the user in the housing module assignment database;
associating the bid from the user token balance with the housing slot; and
issuing the housing module move instruction to the logistics subsystem to transport the housing module to the destination housing module slot.

10. The method of claim 9, further comprising providing an origination housing module development comprising an origination housing module building, wherein:
the origination housing module building includes an origination housing module slot; and
the origination housing module building includes a further utilities interface configured to interface between one or more further utilities and the housing module.

11. The method of claim 10, wherein:
the inter-development housing module transport is further configured to transport the housing module from the origination housing module development;
the inter-building housing module transport is further configured to transport the housing module from the origination housing module building within the origination housing module development; and
the intra-building housing module transport is further configured to transport the housing module from the origination housing module slot within the housing module building;
wherein the logistics subsystem is further configured to, in response to the housing module move instruction issued by a controller, transport the housing module from the origination housing module slot.

12. The method of claim 9, further comprising receiving from a remote device corresponding to the user.

13. The method of claim 12, wherein the remote device is configured to mask a cryptocurrency aspect of the plurality of tokens.

14. The method of claim 9, wherein the housing module includes fittings necessary to attach to the inter-development housing module transport, the inter-building housing module transport, and the intra-building housing module transport.

15. A system, comprising:
a housing module configured to provide a living space for a user;
a destination housing module slot;
a logistics subsystem comprising:
a controller comprising a processor configured to:
issue a plurality of tokens to the user, thereby yielding a user token balance;
receive a bid for the housing module slot, the bid corresponding to a portion of the user token balance;
assign the housing slot to the user;
associate the bid from the user token balance with the housing slot;
issue a housing module move instruction to the logistics subsystem to transport the housing module to the destination housing module slot.

16. The system of claim 15, further comprising a destination housing module development comprising a destination housing module building, wherein the destination housing module building includes the destination housing slot.

17. The system of claim 16, wherein the destination housing module building includes a utilities interface configured to interface between one or more utilities and the housing module.

18. The system of claim 16, wherein the logistics subsystem includes:
an inter-development housing module transport configured to transport the housing module to the destination housing module development; and
an inter-building housing module transport configured to transport the housing module to the destination housing module building within the destination housing module development;
wherein the logistics subsystem is configured to, in response to a housing module move instruction issued by the controller, transport the housing module to the destination housing module slot.

19. The system of claim 15, wherein the controller further comprises an electronic storage device in electronic communication with the processor, the electronic storage device having a token balance database and a housing module assignment database stored thereon.

20. The system of claim 19, wherein the processor is further configured to:
record the user token balance in the token balance database; and
record the assignment of the housing slot to the user in the housing module assignment database.
